(19) United States
(12) Patent Application Publication
(10) Pub. No.: US 2022/0332214 A1
(43) Pub. Date: Oct. 20, 2022

(54) TRACTION BATTERY PACK STATE ESTIMATION

(71) Applicant: Ford Global Technologies, LLC, Dearborn, MI (US)

(72) Inventors: Benjamin A. Tabatowski-Bush, Ann Arbor, MI (US); John Paul Gibeau, Canton, MI (US); Xu Wang, Northville, MI (US); Xianzhi Gong, Novi, MI (US); Baojin Wang, Saline, MI (US)

(21) Appl. No.: 17/234,486

(22) Filed: Apr. 19, 2021

(51) Int. Cl. B60L 58/12; H02J 7/00; B60L 50/64

(52) U.S. Cl. CPC B60L 58/12; H02J 7/0013; H02J 7/0047; B60L 50/64

(57) ABSTRACT

A traction battery arrangement includes a string of cells and bus bars, a coil wrapped around one of the bus bars, and a controller. The controller drives AC current over a swept range of frequencies into the one of the bus bars via the coil, and receives voltage data from at least one of the cells that results from the AC current.

### TECHNICAL FIELD

This disclosure relates to automotive power systems and control of the same.

### BACKGROUND

Electrochemical impedance spectroscopy is a frequency domain measurement made by applying a relatively small sinusoidal perturbation to a system, which is assumed to have a linear response. The impedance at a given frequency is related to processes occurring at timescales of the inverse frequency. Electrochemical impedance spectroscopy may thus be performed by sweeping through a wide range of frequencies at a single perturbation amplitude.

### SUMMARY

An automotive power system has a traction battery including a string of cells and bus bars, a coil wrapped around one of the bus bars, and a controller. The controller drives AC current over a swept range of frequencies into the one of the bus bars via the coil, and receives voltage data from at least one of the cells that results from the AC current.

A method includes driving AC current over a swept range of frequencies into a bus bar of a traction battery of a vehicle via a coil wrapped around the bus bar, receiving voltage data from at least one cell of the traction battery that results from the AC current, and sampling the voltage data according to a phase of the AC current.

A vehicle includes a traction battery and an electric machine, contactors electrically between the traction battery and electric machine, a coil wrapped around a bus bar of the traction battery, and a controller. The controller drives AC current over a swept range of frequencies into the bus bar via the coil, drives current into coils of the contactors, and samples voltage data from at least one cell of the traction battery that results from the AC current according to a phase of the AC current.

### BRIEF DESCRIPTION OF THE DRAWINGS

FIG. 1 is a schematic diagram of a vehicle including a traction battery power system.

FIG. 2 is a plot of battery cell complex versus real impedance over a range of frequencies.

FIG. 3 is a plot of battery cell complex versus real impedance over a range of temperatures and frequencies.

FIG. 4 is a plot of battery cell complex versus real impedance over a range of frequencies at one of the temperatures of FIG. 3.

FIG. 5 is a schematic diagram of a cell equivalent model associated with the plot of FIG. 4.

### DETAILED DESCRIPTION

Detailed embodiments are disclosed herein. It, however, is to be understood that the disclosed embodiments are merely examples that may be embodied in various and alternative forms. The figures are not necessarily to scale; some features may be exaggerated or minimized to show details of particular components. Therefore, specific structural and functional details disclosed herein are not to be interpreted as limiting, but merely as a representative basis for teaching one skilled in the art.

Typically, electrochemical impedance spectroscopy is performed using expensive laboratory equipment. These laboratory machines use very high currents to obtain voltage readings. Attempts to run this testing method without this equipment has two main problems. The first problem is the difficulty to inject a large enough current though the cell. Normal battery controllers may not be built to withstand the amount of current necessary to obtain a useful voltage reading. The second problem is that even if a large enough current could be pushed through the battery packs, the magnitude of resistance is very small, and the readings therefore are too hard to read.

Strategies herein allow such testing to be done with much lower cost equipment but still maintain accurate readings by using magnetic coupling. In a broad sense, these strategies may generate a variable frequency sinusoidal current that is driven through all cells in a traction battery pack, which is a more refined way of determining the impedance of a battery cell. The magnitude of this injected current is such that a response voltage will appear across each individual lithium cell. This voltage can be measured using a battery monitoring integrated circuit, which may be part of a normal battery control system. According to certain embodiments, the magnitude of the cell's response voltage to the injected sinusoid is great enough that it can be measured using a standard battery monitoring integrated circuit. By measuring the voltage response of the cell to a specific frequency and phase of injected current, the complex impedance of each cell can be determined more accurately. Thus, the state of health of the battery can also be determined more efficiently.

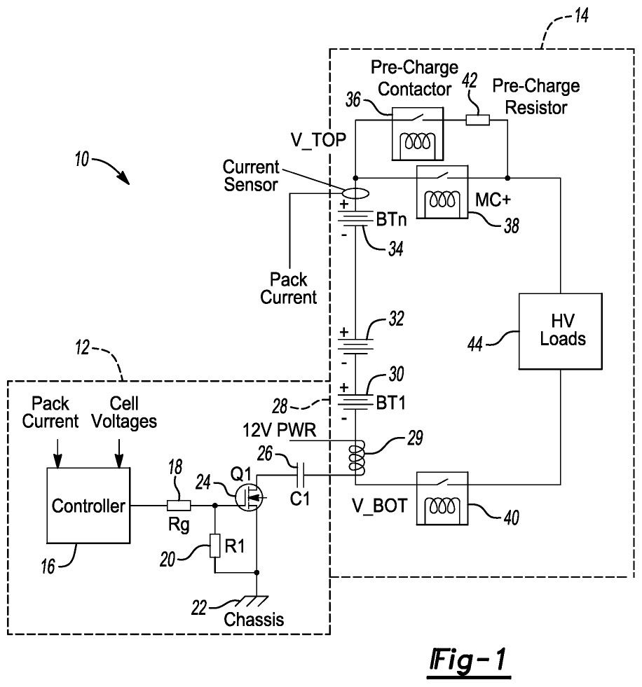

FIG. 1 illustrates a battery system level circuit 10 for performing electrochemical impedance spectroscopy. There are two main sections of this circuit: controller module section 12 and high voltage bus 14. Within the controller module section 12 there is a controller 16, a first resistor 18, a second resistor 20, a chassis 22, a switch 24 (e.g., a metal-oxide-semiconductor field-effect transistor), and a capacitor 26. The controller 16, first resistor 18, switch 24, and capacitor 26 act in series with one another. The second resistor 20 acts as a voltage divider connected to ground 22. In the high voltage bus 14, there is a coil 28 wrapped around a bus bar 29, at least three battery cells 30, 32, 34, three contactors 36, 38, 40, a pre-charge resistor 42, and a high voltage load 44 (e.g., electric machine). The coil 28 may be wrapped around any bus bar associated with the battery cells, including a bus bar between two of the battery cells. The battery cells 30, 32, 34 act in series with one another as well as with the third contactor 40 and the high voltage load 44. The first contactor 36 is in series with the pre-charge resistor 42, and those two are in parallel with the second contactor 38.

The coil 28 is magnetically coupled with the bus bar 29 and is powered by a 12 volt battery in this example. The coil 28 is used to drive AC current into the high voltage bus 14. The controller 16 is programmed to drive AC current over a swept range of frequencies into the bus bar 29 and receive voltage data. The swept range of frequencies will typically be kept between a 1 hertz to a 10 kilo-hertz range. This can be done with a battery monitoring integrated circuit or a centralized battery energy control module, which are not shown in the drawing. It is apparent, however, that the controller 16 receives cell voltage data from voltage sensors associated with the battery cells 30, 32, 34. Certain embodiments also demonstrate a synchronizing capability of the sinusoidal current to the voltage reading of the battery monitoring integrated circuit, which allows a user to take thousands of test cycles and formulate the average reading to obtain a more accurate reading.

The controller 16 can also measure pack current from the pack sensor current which is a cost-efficient way to reuse existing pack current sensors. The pack current sensors can be used for closed loop current control or the current can be used to determine the electrochemical impedance spectroscopy of each cell. That is, the pack current sensor is used to measure the driven sinusoidal current.

The controller 16 is used to represent the central microcontroller in the battery energy control module. The controller 16 generates a pulse width modulated signal which passes through the first and second resistors 18, 20, and turns the switch 24 on or off. The pulse width modulated generated signal and the switch 24 drive the capacitor 26 and the coil 28 for the electrochemical impedance spectroscopy circuit. The controller 16 can also control the switch 24 based on the specified frequency and the pack current to regulate the current coupled to the high voltage bus 14.

The use of the controller 16 to drive the switch 24 is a standard procedure in the battery energy control module space so re-utilizing this hardware helps to reduce the cost of the overall process. It is also useful to utilize this specific circuit in the controller module section 12 because the impedance is similar to that of the contactors 36, 38, and 40 located in the high voltage bus 14. This simplifies the overall circuit. Additionally, the controller 16 may have a daisy chain connection to the battery monitoring integrated circuit, which is used to measure the individual battery cells 30, 32, 34. With this ability, the controller 16 can determine at which point in the sinusoidal wave to trigger a reaction and pick up cell voltage data. Ideally, the controller 16 will utilize optimal points in the sinusoidal wave, for example the peak positive or negative values. In other words, the controller 16 is configured to sample the voltage data according to a phase of the AC current and will take as many samples as according to a predetermined number.

When analyzing the high voltage bus 14, it may be noted that the pre-charge resistor 42 is in series with the first contactor 36. The first contactor 36 and the third contactor 40 will close to create a closed loop throughout the high voltage bus 14, along with the high voltage load 44. Without closing the first contactor 36 and the third contactor 40, the current will not be able to flow through the high voltage bus 14. The current will flow through the first contactor 36 as well as through the pre-charge resistor 42. The pre-charge resistor 42 helps slow the current in order to equalize potential on either side so that contact welding does not happen through the contactors 36, 38, 40. Then the second contactor 38 will close and the first contactor 36 will open. The controller 16 is so arranged with known circuitry to cause current to be driven through coils of the first, second, and third contactors 38, 40, 42 to cause them to close. The source of this current may be the same as the source of the current for the coil 29.

With this method, there is also the opportunity to estimate state of charge. Typically, this process requires the contactors to be opened and then the battery to be left undisturbed for a period of time. With this approach, the open circuit voltage can be taken live which works better in situations where the circuit cannot be opened to take these measurements.

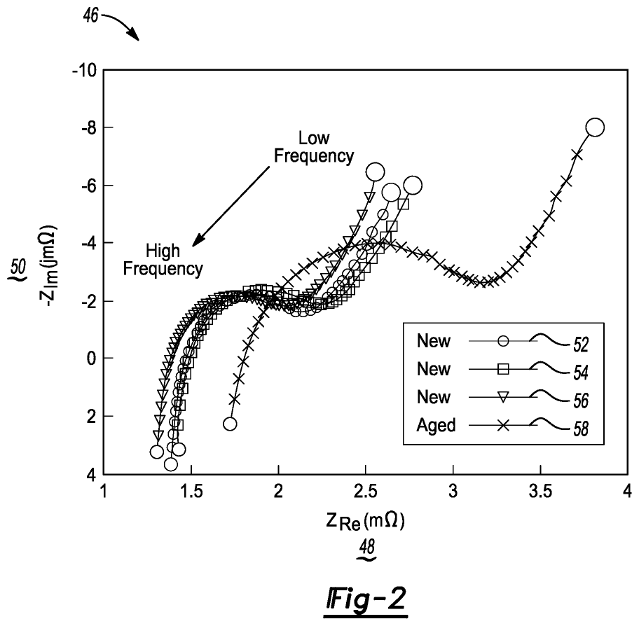

Referring to FIG. 2, this two-dimensional impedance graph 46 shows the impedance being divided between the real part 48 and the imaginary part 50. In this graph, the new battery cells 52, 54, and 56 are compared with an aged battery cell 58 through varying frequencies. The new battery cells 52, 54 and 56 are all closely related with only slight variations, whereas the aged battery cell 58 has a different impedance. This technique can be useful when testing an unknown battery cell. By using this method, the data can be pulled from the unknown battery cell and compared against the impedance graph to determine where on the spectrum it lies.

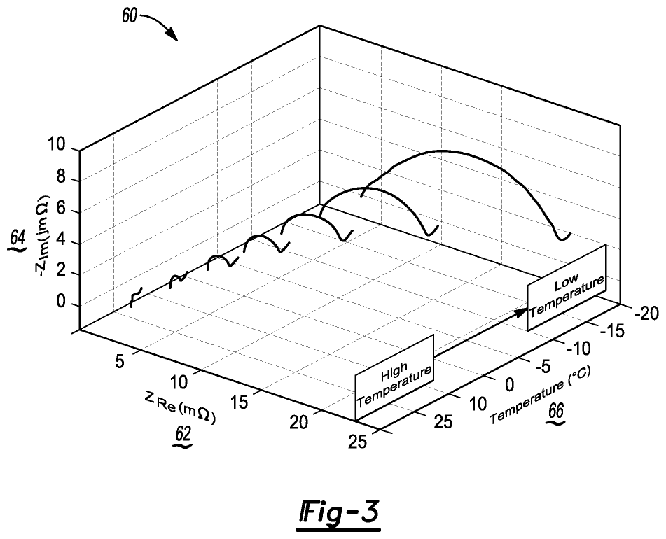

An additional check to test the health status of a battery cell is to determine the impedance in varying temperatures. In FIG. 3, a three-dimensional graph 60 is shown which demonstrates the real part of the impedance 62, the imaginary part of the impedance 64, and varying temperatures 66. As shown, the colder the temperature, the larger the impedance of the equivalent series resistance becomes.

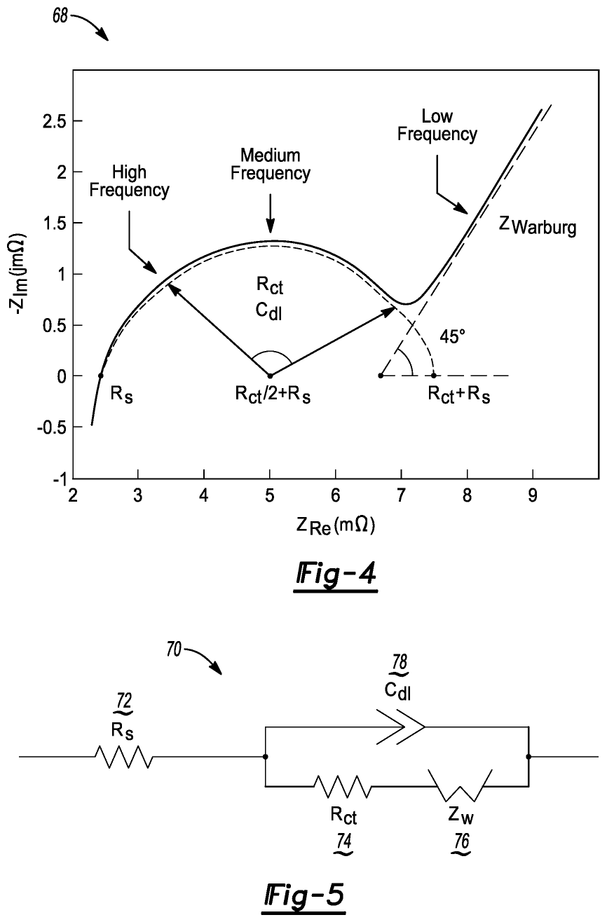

Once all the data is collected using the battery system level circuit 10, there is a need to identify all of the key parameters in one equivalent circuit. FIG. 4 demonstrates a graph to identify the key cell parameters 68 and FIG. 5 demonstrates a cell equivalent circuit model for the electrochemical impedance spectroscopy measurements 70. In the cell equivalent circuit model 70, there are a multitude of parts that could be included. In FIG. 5 specifically, there is an ohmic resistance (Rs) 72, an equivalent resistance (Rct) 74 which determines the charge rate of a battery, a diffusion rate (Zw) 76, and a double layer capacitance (Cdl) 78. The double layer capacitance 78 is forced as ions from the solution as they approach the electrode surface. The value of the double layer capacitance 78 varies depending on the electrode potential, temperature, ionic concentrations, types of ions, oxide layers, electrode roughness, and impurity absorption. This cell equivalent circuit model 70 allows each key concept to be captured in one simple figure.

The processes, methods, or algorithms disclosed herein can be deliverable to/implemented by a processing device, controller, or computer, which can include any existing programmable electronic control unit or dedicated electronic control unit. Similarly, the processes, methods, or algorithms can be stored as data and instructions executable by a controller or computer in many forms including, but not limited to, information permanently stored on non-writable storage media such as read only memory devices and information alterably stored on writeable storage media such as compact discs, random access memory devices, and other magnetic and optical media. The processes, methods, or algorithms can also be implemented in a software executable object. Alternatively, the processes, methods, or algorithms can be embodied in whole or in part using suitable hardware components, such as application specific integrated circuits, field-programmable gate arrays, state machines, controllers or other hardware components or devices, or a combination of hardware, software and firmware components.

While exemplary embodiments are described above, it is not intended that these embodiments describe all possible forms encompassed by the claims. The words used in the specification are words of description rather than limitation, and it is understood that various changes can be made without departing from the spirit and scope of the disclosure.

As previously described, the features of various embodiments can be combined to form further embodiments that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. These attributes may include, but are not limited to cost, strength, durability, life cycle cost, marketability, appearance, packaging, size, serviceability, weight, manufacturability, ease of assembly, etc. As such, embodiments described as less desirable than other embodiments or prior art implementations with respect to one or more characteristics are not outside the scope of the disclosure and can be desirable for particular applications.

What is claimed is:

1. An automotive power system comprising:
a traction battery including a string of cells and bus bars;
a coil wrapped around one of the bus bars; and
a controller programmed to drive AC current over a swept range of frequencies into the one of the bus bars via the coil, and to receive voltage data from at least one of the cells that results from the AC current.

2. The automotive power system of claim 1, wherein the controller is further configured to sample the voltage data according to a phase of the AC current.

3. The automotive power system of claim 2, wherein the controller is further configured to sample the voltage data at a same time the phase indicates a peak value for the AC current for a predetermined number of samples.

4. The automotive power system of claim 3, wherein the controller is further configured to average the samples.

5. The automotive power system of claim 1 further comprising an auxiliary battery electrically connected with the coil.

6. The automotive power system of claim 1 further comprising a switch electrically connected with the coil, wherein the controller is further programmed to modulate the switch to drive the AC current over the swept range of frequencies into the one of the bus bars via the coil.

7. The automotive power system of claim 6 further comprising a capacitor electrically between the switch and coil.

8. The automotive power system of claim 1 further comprising contactors electrically connected with the string, wherein the controller is further programmed to drive current through coils of the contactors.

9. The automotive power system of claim 1 wherein the swept range of frequencies includes 1 Hz and 10 kHz.

10. A method comprising:
driving AC current over a swept range of frequencies into a bus bar of a traction battery of a vehicle via a coil wrapped around the bus bar;
receiving voltage data from at least one cell of the traction battery that results from the AC current; and
sampling the voltage data according to a phase of the AC current.

11. The method of claim 10, wherein the sampling includes sampling the voltage data at a same time the phase indicates a peak value for the AC current for a predetermined number of samples.

12. The method of claim 11 further comprising averaging the samples.

13. The method of claim 10, wherein the driving includes modulating a switch electrically connected with the coil.

14. A vehicle comprising:
a traction battery and an electric machine;
contactors electrically between the traction battery and electric machine;
a coil wrapped around a bus bar of the traction battery; and
a controller programmed to drive AC current over a swept range of frequencies into the bus bar via the coil, to drive current into coils of the contactors, and to sample voltage data from at least one cell of the traction battery that results from the AC current according to a phase of the AC current.

15. The vehicle of claim 14, wherein the controller is further configured to sample the voltage data at a same time the phase indicates a peak value for the AC current for a predetermined number of samples.

16. The vehicle of claim 15, wherein the controller is further configured to average the samples.

17. The vehicle of claim 14 comprising an auxiliary battery electrically connected with the coil.

18. The vehicle of claim 14 further comprising a switch electrically connected with the coil, wherein the controller is further programmed to modulate the switch to drive the AC current over the swept range of frequencies into the bus bar via the coil.
